(19) United States
(12) Patent Application Publication
(10) Pub. No.: US 2015/0234648 A1
(43) Pub. Date: Aug. 20, 2015

(54) FIRMWARE MANAGEMENT SYSTEM, METHOD, AND RECORDING MEDIUM STORING PROGRAM

(71) Applicant: NEC Corporation, Tokyo (JP)

(72) Inventor: Hirooki SHINODA, Tokyo (JP)

(21) Appl. No.: 14/618,140

(22) Filed: Feb. 10, 2015

(30) Foreign Application Priority Data
Feb. 18, 2014 (JP) 2014-028036

(51) Int. Cl. G06F 9/445

(52) U.S. Cl. CPC G06F 8/65

(57) ABSTRACT

A firmware management device according to an exemplary aspect of the invention includes: a first control unit that acquires first update information from a distribution server that makes accessible the first update information indicating that a firmware is under release suspension; and a second control unit that stores second update information, in which the first control unit transmits a command for applying or deleting an update program of the firmware on the basis of the first update information and the second update information stored in the first storage unit.

This application is based upon and claims the benefit of priority from Japanese Patent Application No. 2014-028636, filed on Feb. 18, 2014, the disclosure of which is incorporated herein in its entirety by reference.

### TECHNICAL FIELD

The present invention relates to a firmware management system, a method, and a recording medium storing a program.

### BACKGROUND ART

Japanese Unexamined Patent Application Publication No. 2012-221268 (Patent Literature 1) describes a technique for preventing a distributed firmware found to be problematic from being applied to an image forming apparatus as a distribution destination.

Japanese Patent No. 5261113 (Patent Literature 2) describes a technique for preventing a firmware placed in a release suspension status from being applied or from being used while remaining applied.

In using the techniques of the above Literature, it is impossible to recognize that release of an update program once downloaded has been suspended due to some reason. Accordingly, the techniques of the above Literature have a problem in that such a problematic update program can be applied as it is.

The technique of Patent Literature 1 has a configuration in which a distribution server for distributing a firmware directly instructs application or deletion of the firmware to the image forming apparatus as a management target. Thus, the distribution server described in Patent Literature 1 cannot confirm whether the update program is latest update information or not in accordance with a timing of application on a firmware application target side. Accordingly, the technique has a problem in that even when there is a problem in an update program, the server cannot recognize the fact, so that the update program can be applied as it is.

In Patent Literature 2, the image forming apparatus (corresponding to a management target server of the present invention) periodically executes polling communication with a monitoring host (corresponding to a management device of the present invention) to acquire an instruction (such as application or deletion) generated by the monitoring host. However, in the image forming apparatus, there does not exist an algorithm for determining, upon reception of an instruction for applying an update program, whether the update program is a program under suspension of release. Thus, a problematic update program can be applied.

### SUMMARY

It is an object of the present invention to prevent an update program whose release has been suspended from being applied when applying an update program to a firmware of a management target server.

A firmware management device according to the present invention includes: a first control unit that acquires first update information from a distribution server that makes accessible the first update information indicating that a firmware is under release suspension; and a second control unit that stores second update information, in which the first control unit transmits a command for applying or deleting an update program of the firmware on the basis of the first update information and the second update information stored in the first storage unit.

A method according to the present invention includes: acquiring first update information from a distribution server that makes accessible the first update information indicating that a firmware is under release suspension; storing second update information; and transmitting a command for applying or deleting an update program of the firmware on the basis of the first update information and the second update information.

A non-transitory computer readable recording medium storing a program, according to the present invention, that causes a computer to execute: a processing for acquiring first update information from a distribution server that makes accessible the first update information indicating that a firmware is under release suspension; a processing for storing second update information; and a processing for transmitting a command for applying or deleting an update program of the firmware on the basis of the first update information and the second update information.

### BRIEF DESCRIPTION OF THE DRAWINGS

Exemplary features and advantages of the present invention will become apparent from the following detailed description when taken with the accompanying drawings in which:

FIG. 1 is a block diagram depicting an example of a structure of a firmware management system according to a first exemplary embodiment of the present invention;

FIG. 2 is a block diagram depicting a hardware circuit of an information processor as a computer device that realizes the firmware management device of the first exemplary embodiment of the invention;

FIG. 3 is a diagram depicting a first example of information used for data management of a distribution server;

FIG. 4 is a diagram depicting a second example of information used for the data management of the distribution server;

FIG. 5 is a diagram depicting a first example of information used for data management of a firmware management device;

FIG. 6 is a diagram depicting a second example of information used for the data management of the firmware management device;

FIG. 7 is a sequence diagram depicting an example of an operation of the management system;

FIG. 8 is a flowchart depicting an operation of the firmware management device;

FIG. 9 is a block diagram depicting an example of a structure of a firmware management system according to a second exemplary embodiment of the present invention; and

FIG. 10 is a block diagram depicting an example of a structure of a firmware management device according to a third exemplary embodiment of the present invention.

### EXEMPLARY EMBODIMENT

A first exemplary embodiment for implementing the present invention will be described in detail with reference to the drawings.

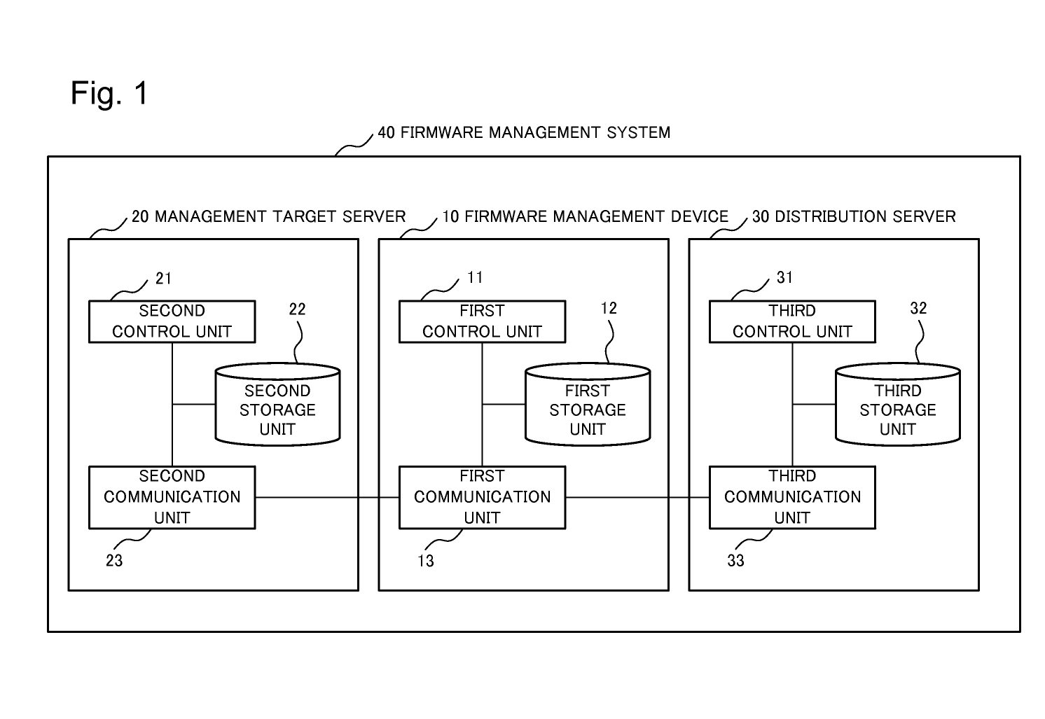

FIG. 1 is a block diagram depicting an example of a structure of a firmware management system 40 according to the first exemplary embodiment of the present invention.

The firmware management system 40 includes a firmware management device 10, a management target server 20, and a distribution server 30.

The firmware management device 10 and the management target server 20 are assumed to be in an environment where they are arranged on the same network and communicable with each other via a local area network (LAN) or the like.

In addition, the firmware management device 10 and the distribution server 30 are assumed to be connected so as to be communicable with each other via the Internet.

The firmware management device 10 manages the management target server 20. In addition, the firmware management device 10 always synchronizes update information indicating that an update program of a firmware (hereinafter referred to simply as “update program”) is under release or under suspension of release with the distribution server 30 so as to allow a target firmware of the management target server 20 to be always updated to latest information.

The firmware management device 10 is, for example, configured by a personal computer (PC).

The firmware management device 10 includes a first control unit 11, a first storage unit 12, and a first communication unit 13.

The first control unit 11 transmits a command for applying or deleting update information of an update program to the management target server 20 via the first communication unit 13. In addition, management software for managing the management target server 20 is installed in the first control unit 11. The first storage unit 12 stores update information acquired by the first communication unit 13 and the first control unit 11 from the distribution server 30. Additionally, the first storage unit 12 also stores structure information of the management target server 20 (such as a name of model of the server and a kind of OS thereof). The first storage unit 12 is a storage device such as a disk device or a semiconductor memory.

The first communication unit 13 has a communication function and, for example, executes transmission and reception of communication data to and from the second communication unit 23 via a LAN. In addition, the first communication unit 13 executes transmission and reception of communication data to and from the third communication unit 33 via the Internet.

The management target server 20 includes a second control unit 21, a second storage unit 22, and a second communication unit 23.

The management target server 20 is a server that is a target to be managed. Additionally, the management target server 20 incorporates a firmware therein. The management target server 20 may be configured by a plurality of server devices.

The second control unit 21 applies or deletes an update program on the basis of update information with respect to an update program to be applied.

The second storage unit 22 stores the update program to be applied. The second storage unit 22 is a storage device such as a disk device or a semiconductor memory.

In a final stage of application to a firmware, the second control unit 21 uses the update program to be applied stored in the second storage unit 22 to execute application or deletion of an update program in a place where each target firmware is stored (such as a flash memory).

The second communication unit 23 has a communication function and, for example, executes transmission and reception of communication data to and from the first communication unit 13 via the LAN.

The distribution server 30 includes a third control unit 31, a third storage unit 32, and a third communication unit 33.

The distribution server 30 has a function of managing an update program under release and an update program whose release has been suspended, whereby update information under release or under suspension of release can be accessed. In addition, the distribution server 30 is assumed to be in an environment where the server 30 is open to public on the Internet and thus accessible from the firmware management device 10.

The distribution server 30 also can transmit update information to the firmware management device 10.

The third control unit 31 transmits update information to the firmware management device 10 via the third communication unit 33.

The third storage unit 32 stores update information. The update information stored in the third storage unit 32 can be viewed on the Internet connected to the distribution server 30. The third storage unit 32 is a storage device such as a disk device or a semiconductor memory.

The third communication unit 33 has a communication function and, for example, executes transmission and reception of communication data to and from the first communication unit 13 via the Internet.

Herein, the first control unit 11, the first communication unit 13, the second control unit 21, the second communication unit 23, the third control unit 31, and the third communication unit 33, respectively, are configured by hardware such as a logical circuit.

In addition, the first control unit 11, the first communication unit 13, the second control unit 21, the second communication unit 23, the third control unit 31, and the third communication unit 33, respectively, may be realized by causing each processor of the firmware management device 10, the management target server 20, and the distribution server 30 as the corresponding computers to execute a program in a not-shown memory.

A target for applying a firmware is, for example, a basic input/output system (BIOS), a base management controller (BMC), or a redundant array of inexpensive disks (RAID) card. However, the target may be all modules operating on a firmware in the management target server 20.

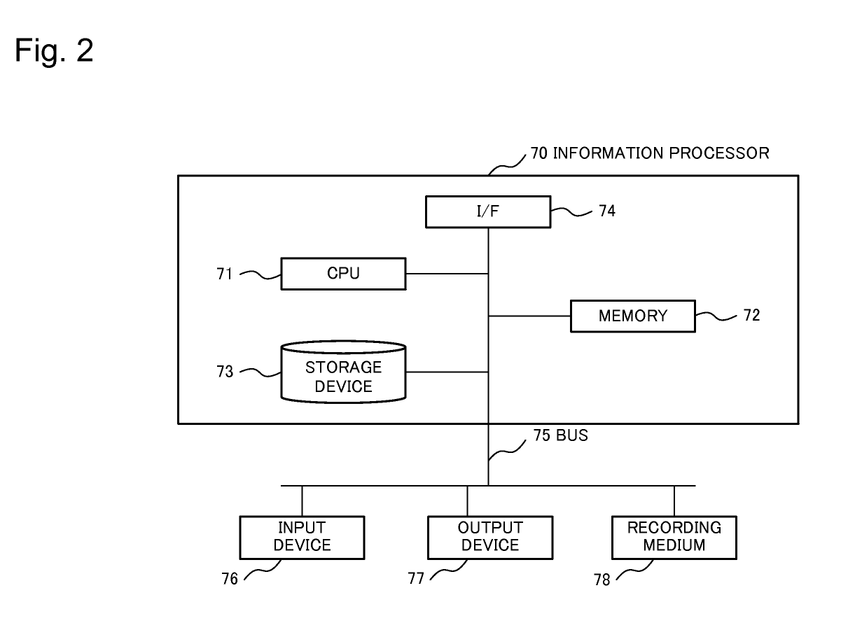

FIG. 2 is a block diagram depicting a hardware circuit of an information processor 70 as a computer device that realizes the firmware management device 10 according to the first exemplary embodiment of the present invention. The management target server 20 and the distribution server 30, respectively, are assumed to have the same structure as that of the firmware management device 10.

As depicted in FIG. 2, the information processor 70 includes a central processor unit (CPU) 71, a memory 72, a storage device 73 such as a hard disk storing a program, and an interface (I/F) 74 for network connection. In addition, the information processor 70 is connected to an input device 76 and an output device 77 via a bus 75. The I/F 74 corresponds to the first communication unit 13, the second communication unit 23, or the third communication unit 33 in FIG. 1.

The CPU 71 entirely controls the information processor 70 by operating an operating system. Additionally, the CPU 71 reads a program or data from a recording medium 78 attached to, for example, a drive device or the like, into the memory 72. In addition, the CPU 71 serves as a part of the first control unit 11, the second control unit 21, or the third control unit 31 in the first exemplary embodiment to execute various kinds of processing on the basis of a program. The CPU 71 in each of the firmware management device 10, the management target server 20, and the distribution server 30 may be formed by a plurality of CPUs.

The storage device 73 is, for example, an optical disk, a flexible disk, a magnetic optical disk, an external hard disk, or a semiconductor memory. The recording medium 78 is a nonvolatile storage device and records a program executed by the CPU 71 therein. The recording medium 78 may be a part of the storage device 73. In addition, the program may be downloaded from a not-shown external computer connected to a communication network via the I/F 74.

The input device 76 is realized, for example, by a mouse, a keyboard, a built-in key button, or the like and used for input operation. The input device 76 is not limited to a mouse, a keyboard, and a built-in key button and may be, for example, a touch panel. The output device 77 is realized, for example, by a display and used to confirm output.

As described hereinabove, each of the firmware management device 10, the management target server 20, and the distribution server 30 in the first exemplary embodiment depicted in FIG. 1 is realized by the hardware structure depicted in FIG. 2. However, the information processor 70 of FIG. 2 is not limited to the structure of FIG. 2. For example, the input device 76 and the output device 77 may be externally attached via the interface 74.

In addition, the information processor 70 may be realized by a physically-combined single device or may be realized by a plurality of devices formed by connecting physically separated two or more devices via a wired or wireless channel.

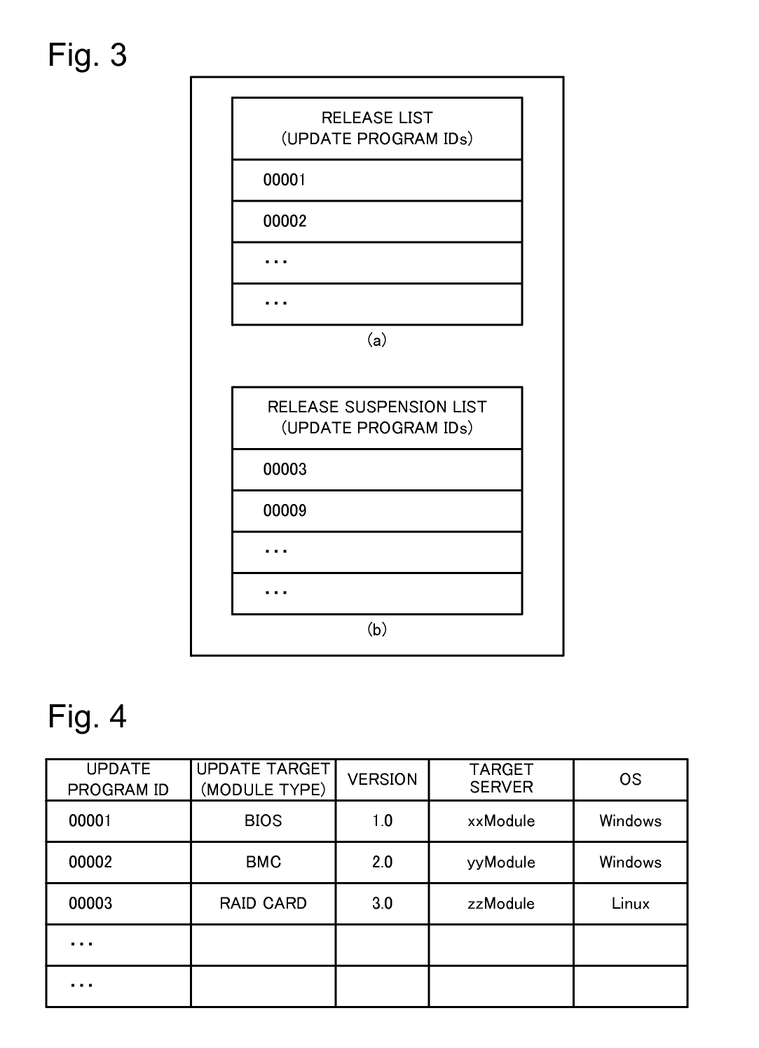

FIG. 3 and FIG. 4 are diagrams each depicting an example of information used for data management of the distribution server 30 and respectively depict pieces of first update information. The pieces of first update information depicted in FIG. 3 and FIG. 4 are stored in the third storage unit 32 of the distribution server 30.

In FIG. 3, list (a) depicts, of the pieces of first update information stored in the third storage unit 32, a list of IDs of update programs currently under release, and list (b) depicts a list of IDs of update programs under release suspension.

FIG. 4 depicts an example of detailed information regarding an update program. In addition, FIG. 4 depicts an example regarding an update target (module type), an update program version, model information of an update target server, and information of an OS (operating system) as an update target, which are corresponding to each update program (update program ID).

The target OS in the example of FIG. 4 is roughly classified into Windows (registered trademark) and Linux (registered trademark) but may be more precisely classified at a more detailed level, for example, “Editions”, such as Windows 2012 and Windows 2008.

In the example of FIG. 4, the update program ID “00003” is included in the release suspension list of FIG. 3, and thus, the update program ID “00003” is an update program that is a target of release suspension.

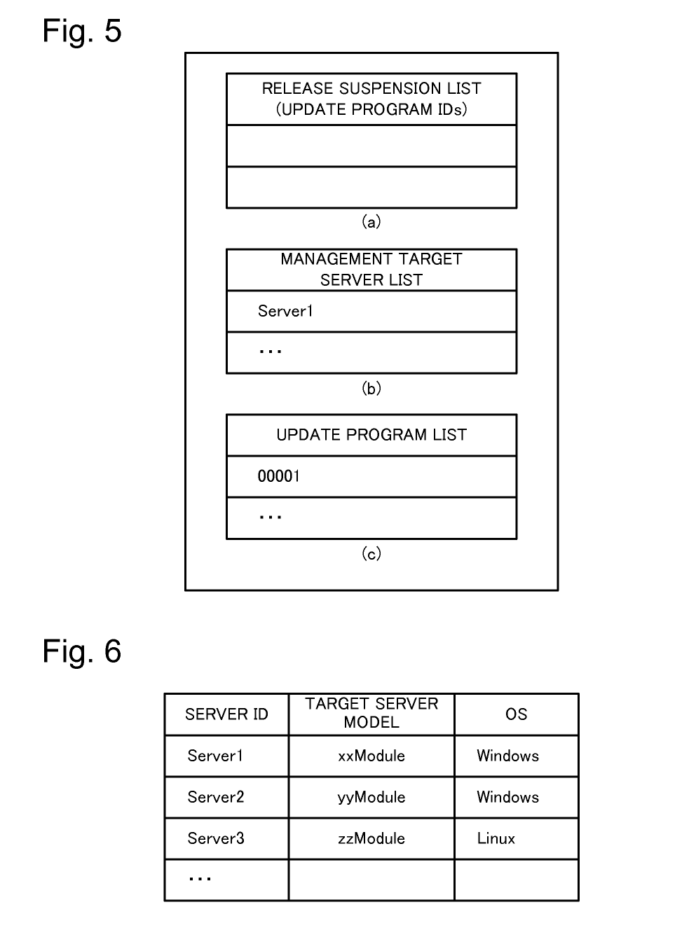

FIG. 5 and FIG. 6 are diagrams each depicting an example of information used for data management of the firmware management device 10 and depict pieces of second update information. The pieces of second update information depicted in FIG. 5 and FIG. 6 are stored in the first storage unit 12 of the firmware management device 10. The firmware management device 10 always updates the second update information depicted in FIG. 5 and FIG. 6 to latest information on the basis of the first update information depicted in FIG. 3 and FIG. 4 and a status of the management target server 20.

In FIG. 5, list (a) depicts, of the pieces of second update information stored in the first storage unit 12, a list of IDs of update programs under release suspension; list (b) depicts a list of the management target server 20 managed by the firmware management device 10 itself; and list (c) depicts a list of update programs managed by the firmware management device 10 itself.

In an initial state, each of these lists is blank. During operation, when needed, the first control unit 11 adds and updates the pieces of information on the basis of information from the distribution server 30.

In the example of FIGS. 5, the release suspension list (a) is blank; the list (b) of the management target server 20 stores “Server 1” as a name of a specific server; and the list (c) of update programs stores update program IDs corresponding to FIG. 4.

FIG. 6 depicts an example of detailed information regarding the management target server 20.

The list of the management target server 20 includes, for example, each server ID assigned to manage the server by the firmware management device 10, model information of the management target server 20, and OS information of the management target server 20, as depicted in FIG. 6.

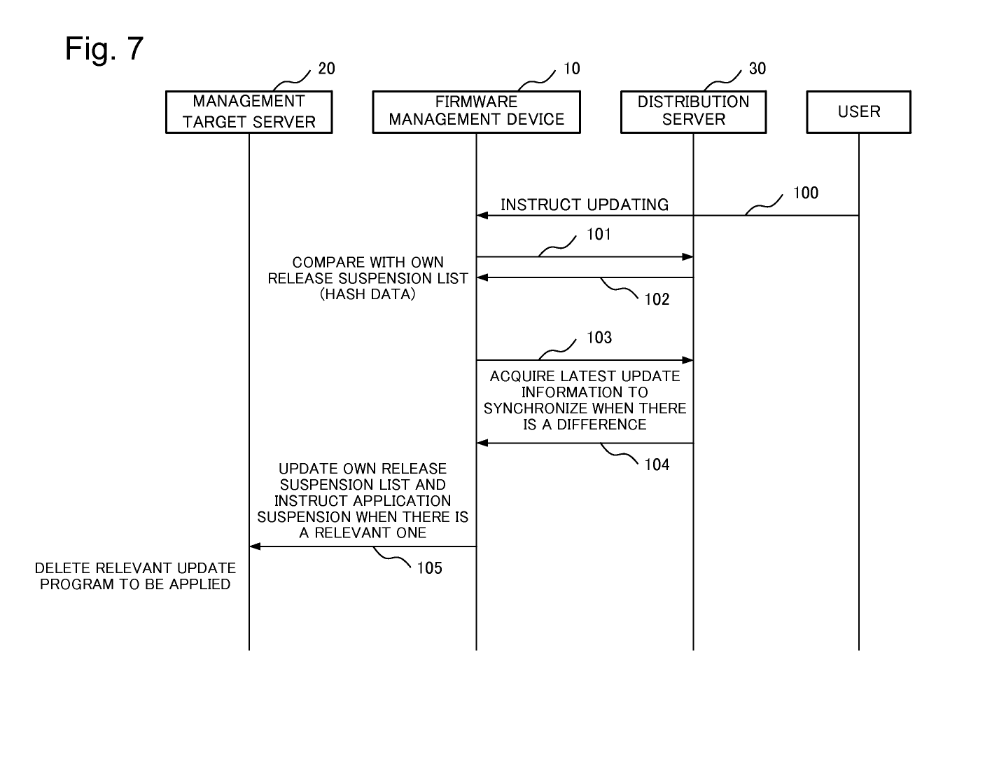

FIG. 7 is a sequence diagram depicting an example of an operation of the firmware management system 40.

First, the firmware management device 10 receives an update instruction to the management target server 20, that is, an instruction 100 for updating a firmware of a relevant module from a user.

Other than the instruction from a user, for example, upon updating of update information, the distribution server 30 may issue an update instruction to the firmware management device 10.

Then, the firmware management device 10 transmits a first data request (or synchronization request) 101 to the distribution server 30 to acquire (download), of the first update information, a list of update programs under release suspension (the release suspension list (b) of FIG. 3) as hash data 102 generated by hashing the list using a hash function from the distribution server 30.

The above hash function means, for example, when certain data is given, an operation for obtaining a numerical value representing the data or a function for obtaining such a numerical value. In addition, the hash function is mainly used for high-speed search, high-speed data comparing processing, and additionally detection of data falsification.

Hashing target data using a hash function leads to reduction in an amount of communication between the firmware management device 10 and the distribution server 30 even when the number of update programs under release suspension increases.

In addition, the firmware management device 10 first acquires the hashed data upon confirmation to the distribution server 30. This allows, with minimum data exchange, synchronization of the release suspension update program list between the distribution server 30 and the firmware management device 10, whereby network load can be reduced.

Next, the firmware management device 10 uses the same hashing algorithm as mentioned above to collectively hash the release suspension update program list (the release suspension list (a) of FIG. 5) of the second update information stored in a database (the first storage unit 12) of the firmware management device 10 itself and compares with the hash data (the update information) acquired from the distribution server 30.

As a result, when there is a difference, latest information is unlikely to be present in the firmware management device 10. Thus, the firmware management device 10 acquires the release suspension update program list (information regarding a relevant update program ID in the list (b) of FIG. 3 and FIG. 4) in a non-hashed form from the distribution server 30 to synchronize information in the list (a) of FIG. 5 of the firmware management device 10 (the first storage unit 12) with the information in the list (b) of FIG. 3 of the distribution server 30. Specifically, the firmware management device 10 transmits a second data request 103 to the distribution server 30 and receives a release suspension update program list ((b) of FIG. 3) 104 in the non-hashed form.

Then, the firmware management device 10 searches the latest release suspension update program list ((c) of FIG. 5) maintained in the firmware management device 10 to determine whether an update program intended to be applied is relevant to any of update programs under release suspension in the list 104. When the update program is relevant to any thereof, the firmware management device 10 transmits an application stop 105 to the management target server 20 to stop application of the update program.

At this time, if an update program under release suspension has already been transmitted to the manage target server 20, the firmware management device 10 will issue an instruction for deleting the update program to the management target server 20.

When there are any other management target servers 20 in a status where the present update program is applicable than the above management target server 20, the firmware management device 10 may issue an instruction for deleting the update program also to those management target servers 20.

After that, the firmware management device 10 deletes the relevant update program from the list ((a) of FIG. 5) of the firmware management device 10.

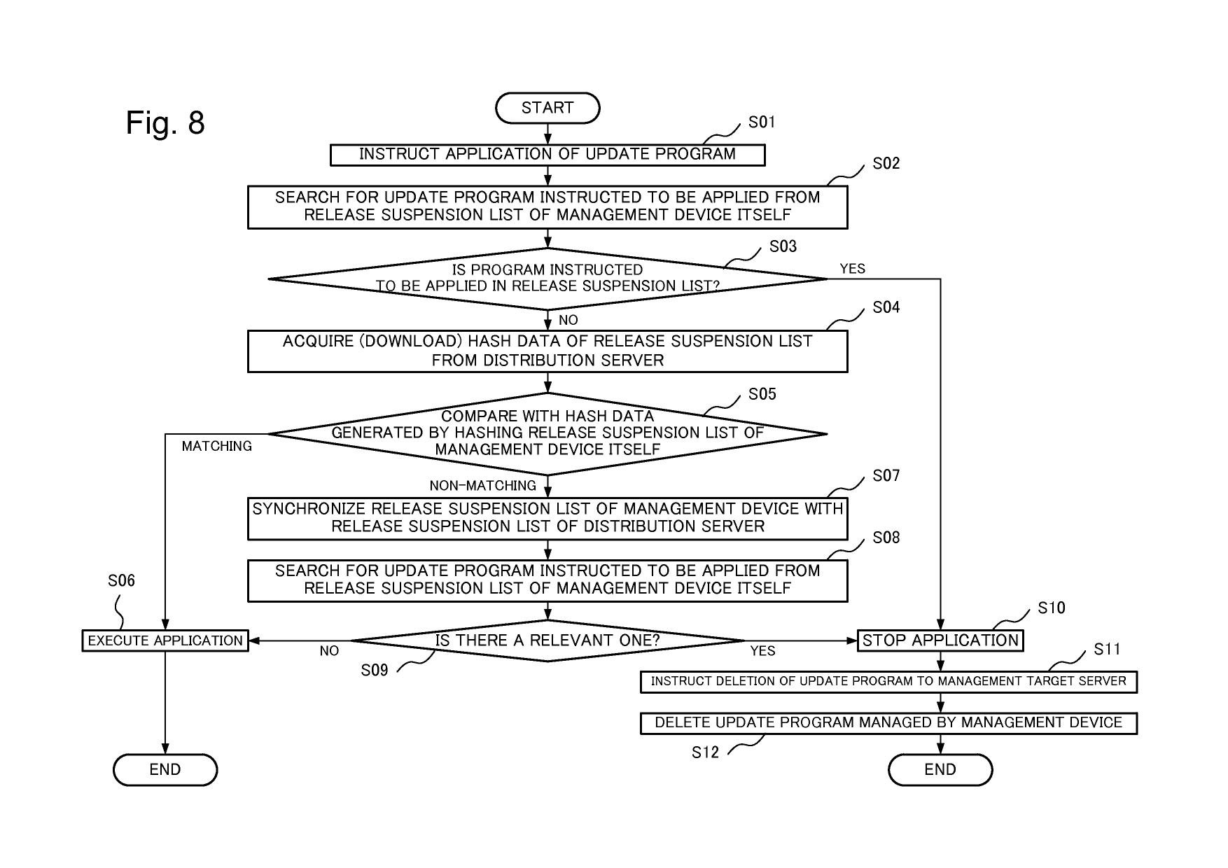

FIG. 8 is a flowchart depicting an operation of the firmware management device 10.

First, the first control unit 11 receives the instruction 100 for applying an update program from a user (FIG. 7) (step S01). The instruction includes an ID of the update program.

Herein, for example, upon updating of the second update information, the distribution server 30 may issue an instruction for updating to the first control unit 11.

Next, the first control unit 11 searches for an update program instructed to be applied (step S02) from the release suspension list ((a) of FIG. 5) of the second update information stored in the first storage unit 12 of the firmware management device 10 itself to confirm whether the update program instructed to be applied is in the release suspension list (step S03).

Then, when the answer is “YES” in step S03, the first control unit 11 determines to stop the application of the relevant update program (step S10).

Next, the first control unit 11 issues an instruction for deleting the relevant update program to the management target server 20 (the second control unit 21) (step S11).

In addition, the first control unit 11 deletes the relevant update program managed in the firmware management device 10 (stored in the first storage unit 12) (step S12).

On the other hand, when the answer is “NO” in step S03, the first control unit 11 checks again using latest data (for example, data hashed due to work efficiency), as described in FIG. 7 (step S04 to S09).

Specifically, first, the first control unit 11 acquires the hash data (first hash data) of the release suspension list ((b) of FIG. 3) of the first update information from the third storage unit 32 (practically, for example, by downloading from a display corresponding to the relevant data) (step S04).

Next, the first control unit 11 compares the second hash data generated by hashing the release suspension list ((a) of FIG. 5) stored in the first storage unit 12 of the management device 10 itself with the first hash data (step S05).

When the comparison result indicates “matching” in step S05, the first control unit 11 executes the application of the relevant update program (transmits a command for the application to the second control unit 21, and then the second control unit 21 executes the command in the management target server 20) (step S06).

On the other hand, when the comparison result indicates “non-matching” in step S05, the first control unit 11 synchronizes the release suspension list of the firmware management device 10 with the release suspension list ((b) of FIG. 3) of the distribution server 30 (step S07). Specifically, the firmware management device 10 acquires the release suspension update program list (information regarding a relevant update program ID in the list (b) of FIG. 3 and FIG. 4) in a non-hashed form from the distribution server 30 and synchronizes the information in the list (a) of FIG. 5 of the firmware management device 10 (the first storage unit 12) with the information in the list (b) of FIG. 3 of the distribution server 30 (rewrites the information in the list (a) of FIG. 5 into the same information as that in the list (b) of FIG. 3).

Then, the first control unit 11 searches for an update program instructed to be applied from the release suspension list (stored in the first storage unit 12) of the firmware management device 10 itself to confirm whether there is an update program relevant to the update program instructed to be applied (steps S08 and S09).

When “YES” is determined in step S09, the first control unit 11 stops the application of the update program (step S 10).

When “NO” is determined in step S09, the first control unit 11 executes the application of the relevant update program (transmits a command for the application to the second control unit 21, and then the second control unit 21 executes the command in the management target server 20) (step S06).

The firmware management system 40 according to the present exemplary embodiment provides an advantageous effect as described below.

When applying an update program to a firmware of the management target server 20, the firmware management system 40 can prevent application of an update program whose release has been suspended.

The reason for that is that when applying an update program, the firmware management device 10 acquires update information from the distribution server 30 and, when the update program is relevant to a program under release suspension, stops the application and deletes the update program.

### Second Exemplary Embodiment

Next, a second exemplary embodiment of the present invention will be described in detail with reference to the drawing.

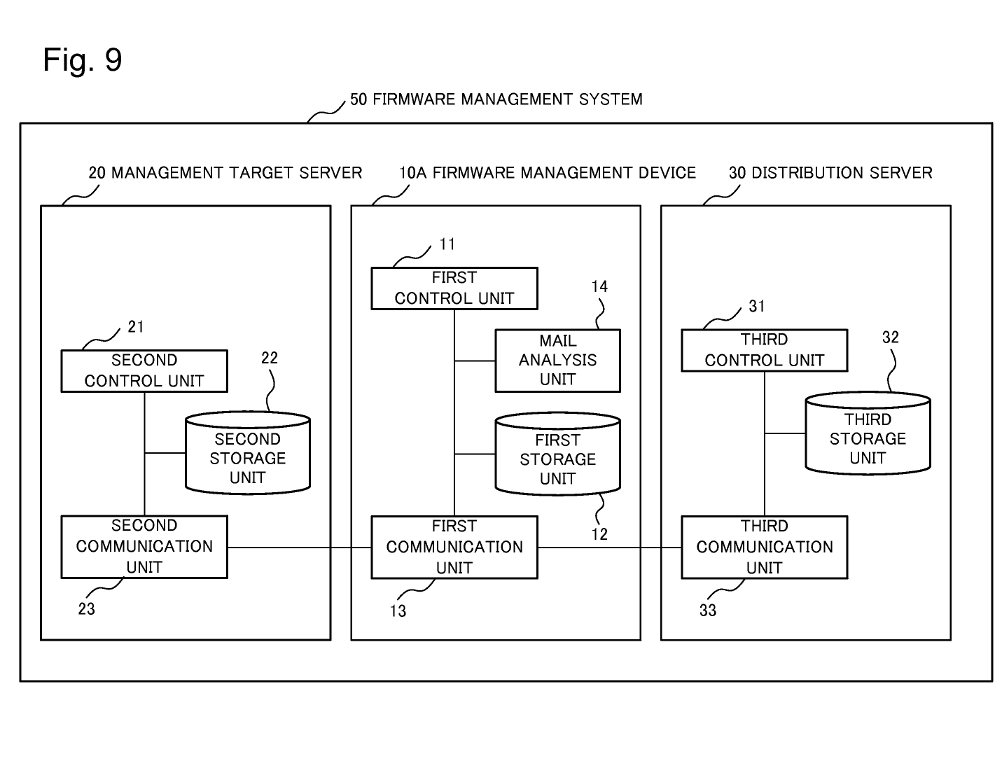

FIG. 9 is a block diagram depicting an example of a structure of a firmware management system 50 according to the second exemplary embodiment of the present invention.

As depicted in FIG. 9, the present exemplary embodiment uses a firmware management device 10A as an alternative to the firmware management device 10 of the first exemplary embodiment. In the firmware management device 10A, a mail analysis unit 14 is further added to the structure of the firmware management device 10. The mail analysis unit 14 is connected to the first control unit 11, the first storage unit 12, and the first communication unit 13.

In the present exemplary embodiment, the third control unit 31 of the distribution server 30 transmits an e-mail including update information of a firmware.

The third communication unit 33 has a function of transmitting the e-mail in accordance with an instruction of the third control unit 31.

In addition, the first communication unit 13 has a function of receiving the e-mail to transmit to the first control unit 11.

Additionally, the third storage unit 32 further stores a mail address of the firmware management device 10.

The third control unit 31 transmits the e-mail including update information to the mail address stored in the third storage unit 32 at a timing when the release suspension list of update programs has been updated.

The update information may be hash data (first hash data) generated by hashing the release suspension list of the update programs by a hash function.

On the other hand, the mail analysis unit 14 of the firmware management device 10 receives the e-mail via the first communication unit 13 and extracts the update information (the first hash data) included in the e-mail to store the update information in the first storage unit 12.

Then, the first control unit 11 compares the update information (the first hash data) acquired from the e-mail with update information (second hash data generated by hashing the release suspension list) stored in the first storage unit 12.

Since procedures after the above-described procedures are the same as those in the first exemplary embodiment (the series of processing after step S05 in FIG. 8), a description thereof will be omitted.

Herein, the mail analysis unit 14 is configured by hardware such as a logical circuit. In addition, the mail analysis unit 14 may be realized by causing the processor of the firmware management device 10 as the computer to execute a program in a not-shown memory.

The firmware management system 50 according to the present exemplary embodiment provides an advantageous effect as described below.

The firmware management system 50 can delete an update program under release suspension at timing when release of the update program has been suspended.

The reason for that is that the distribution serer 30 transmits an e-mail including the information of release suspension at timing when the release suspension list has been updated.

### Third Exemplary Embodiment

Next, a third exemplary embodiment of the present invention will be described in detail with reference to the drawing.

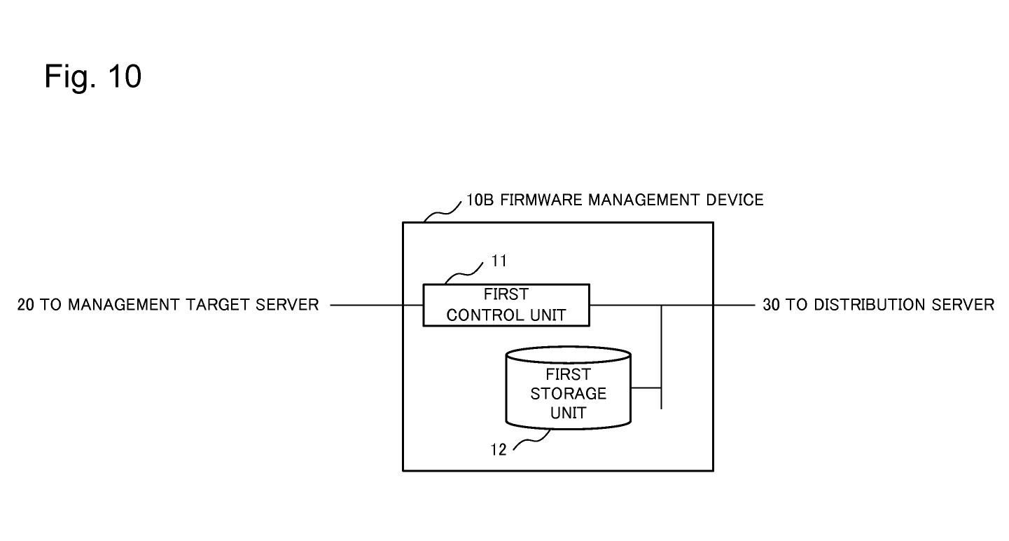

FIG. 10 is a block diagram depicting an example of a structure of a firmware management device 10B according to the third exemplary embodiment of the present invention.

The firmware management device 10B includes the first control unit 11 and the first storage unit 12.

The first control unit 11 acquires first update information from a not-shown distribution server that makes accessible the first update information indicating that a firmware is under release suspension.

The first storage unit 12 stores second update information.

The first control unit 11 transmits a command for applying or deleting the update program of a firmware on the basis of the first update information acquired from the distribution server and the second update information stored in the first storage unit 12.

The firmware management device 10B according to the present exemplary embodiment provides an advantageous effect as described below.

The firmware management device 10B can prevent application of an update program under release suspension when applying an update program to a firmware of the management target server 20.

The reason for that is that when applying an update program, the firmware management device 10B acquires update information from the distribution server 30, and when the program is relevant to a program under release suspension, stops the application and deletes the update program.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A firmware management device comprising:
a first control unit that acquires first update information from a distribution server that makes accessible the first update information indicating that a firmware is under release suspension; and
a second control unit that stores second update information,
wherein the first control unit transmits a command for applying or deleting an update program of the firmware on the basis of the first update information and the second update information stored in the first storage unit.

2. A firmware management system comprising:
the first firmware management device according to claim 1; and
a management target server including a second storage unit that stores a update program to be applied and a second control unit that receives the command and, based on the command, applies or deletes the update program of the firmware with respect to the update program to be applied.

3. The firmware management system according to claim 2,
wherein the distribution server includes a third control unit that transmits the first update information; and
wherein the first control unit synchronizes the second update information stored in the first storage unit with the first update information received from the third control unit.

4. The firmware management system according to claim 2,
wherein the third control unit generates first hash data by hashing the first update information and transmits the first hash data; and
wherein the first control unit generates second hash data by hashing the second update information stored in the first storage unit, and synchronizes the second update information stored in the first storage unit with the first update information received from the third control unit when there is a difference between the first hash data and the second hash data.

5. The firmware management system according to claim 2,
wherein the third control unit transmits an e-mail including the first update information or the first hash data; and
wherein the firmware management device further comprises a mail analysis unit that receives the e-mail and extracts the first update information or the first hash data from the e-mail to store in the first storage unit.

6. A method comprising:
acquiring first update information from a distribution server that makes accessible the first update information indicating that a firmware is under release suspension;
storing second update information; and
transmitting a command for applying or deleting an update program of the firmware on the basis of the first update information and the second update information.

7. The method according to claim 6, wherein the method stores an update program to be applied, receives the command and, based on the command, applies or deletes the update program of the firmware with respect to the update program to be applied.

8. The method according to claim 6, wherein the method synchronizes the second update information with the first update information.

9. The method according to claim 6, wherein the method generates first hash data by hashing the first update information, generates second hash data by hashing the second update information, and synchronizes the second update information with the first update information when there is a difference between the first hash data and the second hash data.

10. A non-transitory computer readable recording medium storing a program that causes a computer to execute:
a processing for acquiring first update information from a distribution server that makes accessible the first update information indicating that a firmware is under release suspension;
a processing for storing second update information; and
a processing for transmitting a command for applying or deleting an update program of the firmware on the basis of the first update information and the second update information.
